(19) United States
(12) Patent Application Publication
(10) Pub. No.: US 2007/0220955 A1
(43) Pub. Date: Sep. 27, 2007

(54) Structure of gas sensor ensuring enhanced mechanical durability

(75) Inventors: Hirofumi Noda, Kariya-shi (JP); Taiji Yokoyama, Toyoake-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/723,760

(22) Filed: Mar. 21, 2007

(30) Foreign Application Priority Data
Mar. 21, 2006 (JP) 2006-077875
Feb. 19, 2007 (JP) 2007-038135

(51) Int. Cl. G01N 27/00; G01M 15/10

(52) U.S. Cl. 73/31.05; 73/23.31

(57) ABSTRACT

A gas sensor includes a heater, leads connecting electrically with terminals of the heater, and a porcelain insulator surrounding the terminals of the heater within an air cover. The gas sensor also includes a recess formed in an end of the porcelain insulator to define a clearance between itself and an inner wall of the air cover. A gas flow path is defined to extend from an inner chamber of the air cover to a ventilator through a clearance between an outer periphery of the porcelain insulator and an inner periphery of the air cover and the recess to lead the gas having entered the inner chamber outside the sensor, thereby minimizing the entrance of the gas into the porcelain insulator to avoid the exposure of the terminals to the gas. This avoids the corrosion of the terminals with the gas to ensure the mechanical durability of the gas sensor.

### CROSS REFERENCE TO RELATED DOCUMENT

The present application claims the benefit of Japanese Patent Application No. 2006-77875 filed on Mar. 21, 2006, the disclosure of which is totally incorporated herein by reference.

### BACKGROUND OF THE INVENTION

1. Technical Field of the Invention

The present invention relates generally to a gas sensor which is installed, for example, in an exhaust system of automotive internal combustion engines to measure a specified component of exhaust emissions, and more particularly to an improved structure of such a gas sensor which is designed to has enhanced mechanical durability.

2. Background Art

Japanese Patent First Publication No. 2001-330584 discloses a gas sensor to be installed in an exhaust pipe of automotive internal combustion engines to measure the concentration of a preselected gas contained in exhaust emissions from the engine. FIG. 12 shows such a type of gas sensor 9.

The gas sensor 9 consists essentially of a sensor element 92 sensitive to the concentration of gas, a heater 93 embedded in the sensor element 92, and a housing 94 retaining therein the sensor element 92. The gas sensor 9 also includes an air cover 95 joined to a base end of the housing 94 and an porcelain insulator 97 disposed inside the air cover 95. The porcelain insulator 97 has retaining therein leads 912 which electrically connect with the sensor element 92 and the heater 93.

The heater 93 has affixed thereon terminals 930 which lead electrically to the leads 912. An insulating member 913 and powder seal 914 are disposed between the outer periphery of the sensor element 92 and the inner wall of the housing 94. The housing 94 has an annular end which is crimped inwardly to press the insulating member 913 and the powder seal 914 to hold the sensor element 92 firmly.

In recent years, the temperature of exhaust gas of automotive engines has been increased in order to meet tightened legal requirements of emission control, thus resulting in increased thermal loads on the powder seal 914, which gives rise to a decrease in degree of air-tightness between the housing 94 and the sensor element 92. This causes the exhaust gas, as indicated by an arrow in FIG. 12, to leak into the air cover 95 along a path 960 between the sensor element 92 and the housing 94. The exhaust gas subsequently advances along a path 962 within an inner chamber 970 of the porcelain insulator 97 and goes out of the air cover 95 from air inlets 98 formed in the base end portion of the air cover 95. The terminals 930 of the heater 93 is disposed in the gas leakage path 962, so that it is exposed to and corroded with the gas, thus resulting in a drop in durability of the gas sensor 9.

The entrance of the gas into the air cover 95 will also result in a change in concentration of oxygen (O₂) within an air chamber 950 defined inside the air cover 95, thus leading to an error of an output of the sensor 9.

### SUMMARY OF THE INVENTION

It is therefore a principal object of the invention to avoid the disadvantages of the prior art.

It is another object of the invention to provide an improved structure of a gas sensor which is designed to have enhanced mechanical durability.

According to one aspect of the invention, there is provided an improved structure of a gas sensor which may be employed in measuring the concentration of a given component of exhaust emissions from automotive engines. The gas sensor has a length with a top end and a base end opposite the top end and comprises: (a) a sensor element responsive to a concentration of a given gas to output a signal indicative thereof; (b) a heater disposed inside the sensor element to heat the sensor, the heater having a base end, a top end opposite the base end, and a terminal provided on an outer surface of the base end; (c) a housing having a top end and a base end opposite the top end, the housing retaining the sensor element therethrough; (d) leads connecting electrically with the sensor element and the terminal of the heater; (e) a porcelain insulator retaining the leads therein and surrounding the terminal of the heater, the porcelain insulator having a shoulder surface; (f) an air cover including a large-diameter portion, a small-diameter portion, and a shoulder formed between the large-diameter portion and the small-diameter portion, the large-diameter portion being joined to the base end of the housing, the small-diameter portion being equipped with a ventilator, the air cover retaining therein the porcelain insulator in abutment of the shoulder with the shoulder surface of the porcelain insulator; (g) a recess formed in the shoulder surface of the porcelain insulator; (h) an inner chamber defined inside the air cover between the porcelain insulator and the base end of the housing; and (i) an outer gas flow path defined to extend from the inner chamber to the ventilator through a clearance between an outer periphery of the porcelain insulator and an inner periphery of the air cover and the recess to lead the gas having entered the inner chamber outside the sensor.

Specifically, when the gas to be measured has leaked from the housing into the inner chamber, the outer gas flow path serves to drain it outside the gas sensor through the ventilator, thereby minimizing the entrance of the gas into the porcelain insulator to avoid the exposure of the terminal to the gas. This avoids the corrosion of the terminal with the gas to ensure the mechanical durability of the gas sensor.

The recess forms a clearance between the shoulder surface of the porcelain insulator and an inner wall of the shoulder of the air cover to define a portion of the outer gas flow path, thereby facilitating ease of flow of the gas from the inner chamber to the ventilator.

The porcelain insulator surrounds the terminal of the heater, thereby minimizing direct contact of the terminal with the gas and facilitating the flow of the gas along the outer gas flow path.

In the case where the inner chamber is filled with air introduced from outside the ventilator as a reference gas used to measure the concentration of the gas, the outer gas flow path serves to minimize mixing of the gas with the air, thus ensuring the accuracy of output of the gas sensor.

In the preferred mode of the invention, the terminal of the heater has a top end and a base end which is opposite the top end and located closer to the top end of the sensor then the base end thereof. The porcelain insulator has a top end located closer to the top end of the sensor than the top end of the terminal of the heater, thereby minimizing the exposure of the terminal with the gas.

The gas sensor further comprises an inner gas flow path defined to extend from the inner chamber to outside the sensor through an inner chamber which is formed inside the porcelain insulator and through which the lead extend. The outer gas flow path has a minimum cross sectional area Sa defined perpendicular to a length thereof. The inner gas flow path has a minimum cross sectional area Sb which is defined perpendicular to a length thereof and meets a relation of Sa/Sb≧2, and preferably Sa/Sb≧5. This decreases the amount of the gas drained through the inner gas flow path to be smaller than that drained through the outer gas flow path, thereby minimizing the exposure of the terminal with the gas to avoid the corrosion of the terminal.

The gas sensor may further comprise a sealing member disposed on a base end of said porcelain insulator located closer to the base end of the gas sensor to block said outer gas flow path.

The gas sensor may alternatively comprise a shroud with a first end and a second end opposite the first end. The shroud is installed at the first end thereof on the base end of the sensor element and extends to have the second end around an outer periphery of the porcelain insulator to direct flow of the gas to said outer gas flow path.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a longitudinal sectional view which shows a structure of a gas sensor according to the first embodiment of the invention;

FIG. 2 is a transverse sectional view, as taken along the line A-A in FIG. 1;

FIG. 3 is a longitudinal sectional view which shows a structure of a gas sensor according to the second embodiment of the invention;

FIG. 4 is a longitudinal sectional view which shows a structure of a gas sensor according to the third embodiment of the invention;

FIG. 5 is a longitudinal sectional view which shows a structure of a gas sensor according to the fourth embodiment of the invention;

FIG. 6 is a partially longitudinal sectional view which shows the structure of test samples of a gas sensor to evaluate the degree of corrosion of joints between leads and terminals of a heater;

FIG. 7 is a graph which represents the percentage of corrosion of the joints between the leads and the terminals of the heater installed in the test samples, as illustrated in FIG. 6;

FIG. 8 is a partially longitudinal sectional view which shows the structure of test samples of a gas sensor to evaluate the concentration of gas around joints between leads and terminals of a heater;

FIG. 9 is a graph which represents the concentration of gas around the joints between the leads and the terminals of the heater in the test samples of FIG. 8;

FIG. 10 is a partially longitudinal sectional view which shows the structure of test samples of a gas sensor to evaluate the percentage of occurrence of dew condensation on joints between leads and terminals of a heater;

FIG. 11 is a graph which represents the percentage of occurrence of dew condensation on the joints between the leads and the terminals of the heater in the test samples of FIG. 10; and

FIG. 12 is a longitudinal sectional view which shows the structure of a conventional gas sensor.

### DESCRIPTION OF THE PREFERRED EMBODIMENTS

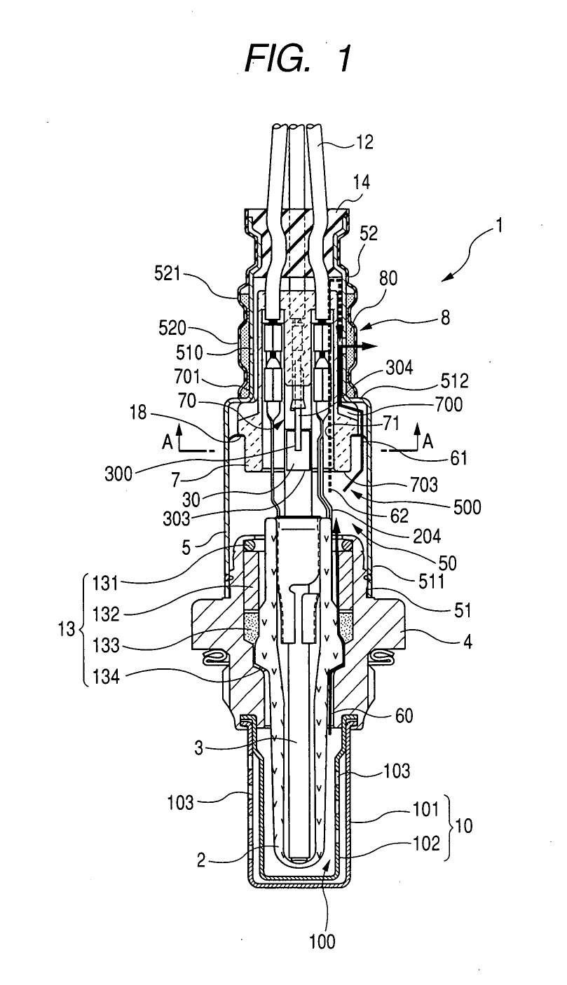

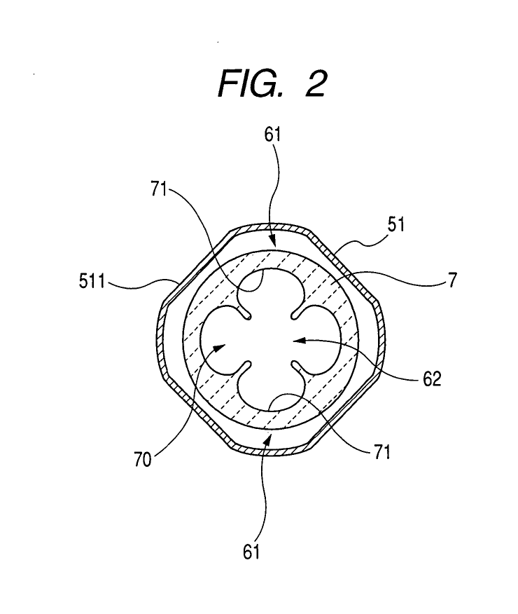

Referring to the drawings, wherein like reference numbers refer to like parts in several views, particularly to FIGS. 1 and 2, there is shown a gas sensor 1 according to the first embodiment of the invention which is designed to be installed in an exhaust pipe of an automotive internal combustion engine to measure the concentration of a component such as O₂, NOx, CO, or HC of exhaust gasses for burning control of the engine.

The gas sensor 1 includes a sensor element 2, a bar-shaped ceramic heater 3 working to heat the sensor element 2 up to a desired activation temperature thereof, and a housing 4 retaining the sensor element 2.

The gas sensor 1 also includes an air cover 5 joined to a base end (i.e., an upper end, as viewed in FIG. 1) of the housing 4, leads 12 connecting electrically with the heater 3 and the sensor 2, and a porcelain insulator 7 held in the air cover 5 to retain the leads 12 therein.

The air cover 5 is made up of a large-diameter portion 511, a small-diameter portion 521 extending from the large-diameter portion 511 away from the housing 4, and a shoulder 512 formed between the large-diameter portion 511 and the small-diameter portion 521.

The small-diameter portion 521 has formed therein ventilators 8 through which air enters the air cover 5 as a reference gas.

The heater 3 has affixed on the surface thereof terminals 30 connecting with the leads 12.

The porcelain insulator 7 has a shoulder surface 701 placed in abutment with the shoulder 512 of the air cover 5 and a plurality of recesses or grooves 700 formed in the shoulder surface 701. The porcelain insulator 7 surrounds the terminals 30 of the heater 3 and has a top end 703 located closer to the top (i.e., a lower end, as viewed in FIG. 1) of the gas sensor 1 than a top end 303 of each of the terminals 30 of the heater 3.

The porcelain insulator 7, as can be seen from FIGS. 1 and 2, defines an outer gas flow path 61 between the outer periphery thereof and the inner periphery of the air cover 5. The outer gas flow path 61 extends from an inner chamber 50 defined inside the air cover 5 beneath the top end 303 of the porcelain insulator 7, as viewed in FIG. 1, to outside the air cover 5 through the grooves 700 and the ventilators 8.

The outer gas flow path 61 has a minimum cross sectional area Sa extending in a direction perpendicular to a length thereof (i.e., a direction of extension thereof). The gas sensor 1 also has an inner gas flow path 62 extending outside the air cover 5 through an inner chamber 70 which is defined inside the porcelain insulator 7 and through which the leads 12 pass. Specifically, the inner gas flow path 62, as indicated by a broken line, extends straight upward, passes through clearances between the leads 12 and the porcelain insulator 7, makes a U-turn downward, turns at right angles, and then goes outside the air cover 5 through the ventilators 8. The inner gas flow path 62 has a minimum cross sectional area Sb extending in a direction perpendicular to a length thereof (i.e., a direction of extension thereof. The minimum cross sectional areas Sa and Sb meet a relation of Sa/Sb≧2, and preferably Sa/Sb≧5.

The porcelain insulator 7 is, as clearly shown in FIG. 1, urged within the air cover 5 by an annular press plate 18 into abutment of the shoulder surface 701 with the shoulder 512 of the air cover 5.

The grooves 700 are formed by cutting out a plurality of portions of the shoulder surface 701 to define flow paths between themselves and the inner surface of the shoulder 512 which form a portion of the outer gas flow path 61.

Each of the terminals 30 of the heater 3 has a terminal lead 304 connected thereto through a soldered or brazed joint 300.

The sensor element 2 has a pair of terminal leads 204 connecting with a pair of electrodes affixed to outer and inner surfaces of the body of the sensor element 2. Two of the four leads 12 are connected electrically with the terminal leads 304 of the heater 3, and the other two are connected electrically with the terminal leads 204 of the sensor element 2.

The porcelain insulator 7 has formed therein, as clearly shown in FIG. 2, four holes 71 which form the part of the inner chamber 70 and through which the leads 12 extend in connection with the sensor element 2 and the heater 3.

Disposed within the base end of the air cover 5 is a rubber bush 14 through which the leads 12 pass in tight fit. The based end of the air cover 5 is, as can be seen from FIG. 1, crimped inwardly to retain the rubber bush 14 tightly and establish a liquid-tight seal in the base end of the gas sensor 1.

The air cover 5 consists of a dust cover 51 and a filter cover 52. The dust cover 51 is joined or welded to the base end of the housing 4. The filter cover 52 surrounds a base end portion (i.e., a small-diameter portion) of the dust cover 51.

Specifically, the small-diameter portion of the air cover 5 is made up of the base end portion of the dust cover 51 and the filter cover 52. Retained between the base end portion of the dust cover 51 and the filter cover 52 is a cylindrical water-repellent filter 80 which allows air to passes therethrough.

The filter cover 52 has air inlets 520 formed circumferentially. The dust cover 51 has air passage openings 510 formed in the base end portion thereof circumferentially. Each of the ventilators 8 is made up of one of the air inlets 520, one of the air passage openings 510, and the filter 80.

The air, as used as the reference gas in the sensor element 2, enters the air inlets 520 from outside the gas sensor 1 and flows into the air cover 5 through the filter 80 and the air passage openings 510 to create an air atmosphere 500.

The gas sensor 1 also includes a protective gas cover assembly 10 which is installed in an annular groove formed in the top end of the housing 4. The gas cover assembly 10 is made up of made up of an outer cover 101 and an inner cover 102 both of which have gas inlets 103 through which a gas to be measured (will also be referred to as a measurement gas below) is admitted into a gas chamber 100 to which the sensor element 2 is exposed.

The gas sensor 1 also includes a sealing assembly 13 which is disposed between the inner wall of the housing 4 and the outer wall of the sensor element 2. The sensor element 2 is retained firmly within the housing 4 by crimping or bending an annular extension (i.e., the base end) of the housing 4 inwardly to press the sensor element 2 through the sealing assembly 13 against the inner wall of the housing 4. The sealing assembly 13 is made up of a metal ring 131, an insulator 132, a powder seal 133 made of talc etc., and a metal gasket 134. The insulator 132 works to insulate the sensor element 2 from the housing 4 electrically. The metal ring 131 is disposed between the crimped base end of the housing 4 and the insulator 132 in abutment therewith to achieve a hermetical seal therebetween. The metal gasket 134 is disposed between an outer annular tapered shoulder of the sensor element 2 and an inner annular tapered shoulder of the housing 4 to enhance adhesion therebetween. Specifically, the sealing assembly 13 works to establish a liquid-tight seal between the gas chamber 100 defined on the side of the top end of the housing 4 and the air atmosphere 500 defined on the side of the base end of the housing 4.

With a rise in temperature of exhaust gas of the automotive engine in order to meet modern legal requirements of emission control, the sealing assembly 13 thermally deteriorates, thereby causing, for example, the measurement gas to enter the air cover 5 through a clearance path(s) 60 between the sensor element 2 and the housing 4. Specifically, the thermal deterioration of the sealing assembly 13 results in formation of the clearance path(s) 60 through which the measurement gas is admitted into the air cover 5.

The measurement gas having entered the inner chamber 50 of the air cover 5 passes through the grooves 700 and escapes out of the gas sensor 1 through the ventilators 8 along the outer gas flow path 61. Specifically, the measurement gas having entered the inner chamber 50 is discharged outside the gas sensor 1 without almost touching the brazed joints 300 of the terminals 30.

The feature of the structure of the gas sensor 1 of this embodiment will be described below in detail.

Between the outer peripheral surface of the porcelain insulator 7 and the inner peripheral surface of the air cover 5, the outer gas flow path 61 is formed which works to lead the measurement gas having entered the air cover 5 to outside the gas sensor 1, thereby minimizing the entrance of the measurement gas into the inner chamber 70 of the porcelain insulator 70 within which the terminals 30 of the heater 3 are disposed. This minimizes the corrosion of the terminals 30, especially the brazed joints 300 of the heater 3 with the measurement gas, thereby ensuring the stability of joining of the terminal leads 304 to the terminals 30 of the heater 3 to improve the durability of the gas sensor 1.

The grooves 700 formed in the shoulder surface 701 of the porcelain insulator 7 form between the porcelain insulator 7 and the shoulder 512 of the air cover 5 clearances which establish a required volume of the outer gas flow path 61, thereby facilitating the draining of the measurement gas outside the gas sensor 1 through the outer gas flow path 61. This minimizes mixing of the measurement gas with the air atmosphere 500 to avoid an undesirable change in concentration of, for example, oxygen contained in the air to assure the accuracy of an output of the gas sensor 1.

The porcelain insulator 7 serves to shield the terminals 30 of the heater 3 from the measurement gas, thus minimizing the contact of the terminals 30 with the measurement gas to decrease the corrosion of the terminals 30.

The outer gas flow path 61, as already described, has the minimum cross sectional area Sa. The inner gas flow path 62 has the minimum cross sectional area Sb. The minimum cross sectional areas Sa and Sb meet a relation of Sa/Sb≧2, and preferably Sa/Sb≧5. This decreases the flow rate of the measurement gas drained outside the gas sensor 1 through the inner gas flow path 62 much below that through the outer gas flow path 61, thus minimizing the exposure of the terminals 30 of the heater 3 to the measurement gas to avoid the corrosion thereof. When Sa/Sb≧5, it will result in a further decreased amount of the measurement gas to which the terminals 30 of the heater 3 are exposed, thus minimizing the corrosion of the terminals 30 further.

In stead of the grooves 700, a single groove or recesses may be formed in the shoulder surface 701 of the porcelain insulator 7 to define the part of the outer gas flow path 61.

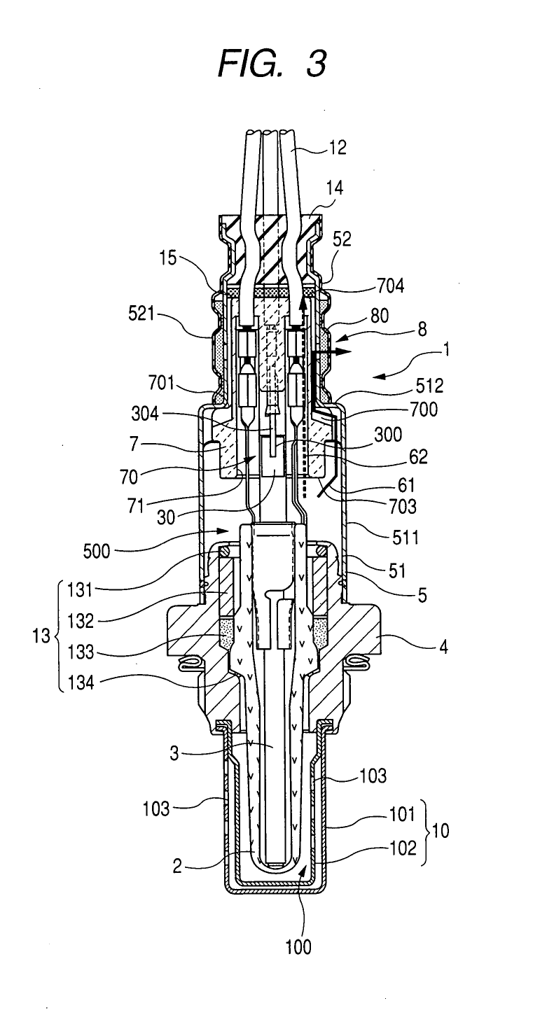

FIG. 3 illustrates the gas sensor 1 according to the second embodiment of the invention which is different in structure from the first embodiment in that a sealing member 15 is disposed between the rubber bush 14 and the porcelain insulator 7.

The sealing member 15 is placed in direct contact with the base end surface 704 of the porcelain insulator 7 to seal clearances between inner walls of the holes 71 and outer peripheries of the leads 12 hermetically, thereby blocking the inner gas flow path 62, as indicated by an arrow of a broken line in the drawing. This disables the flow of the measurement gas through the porcelain insulator 7 to avoid the exposure of the terminals 30 of the heater 3 to the measurement gas. Other arrangements are identical with those in the first embodiment, and explanation thereof in detail will be omitted here.

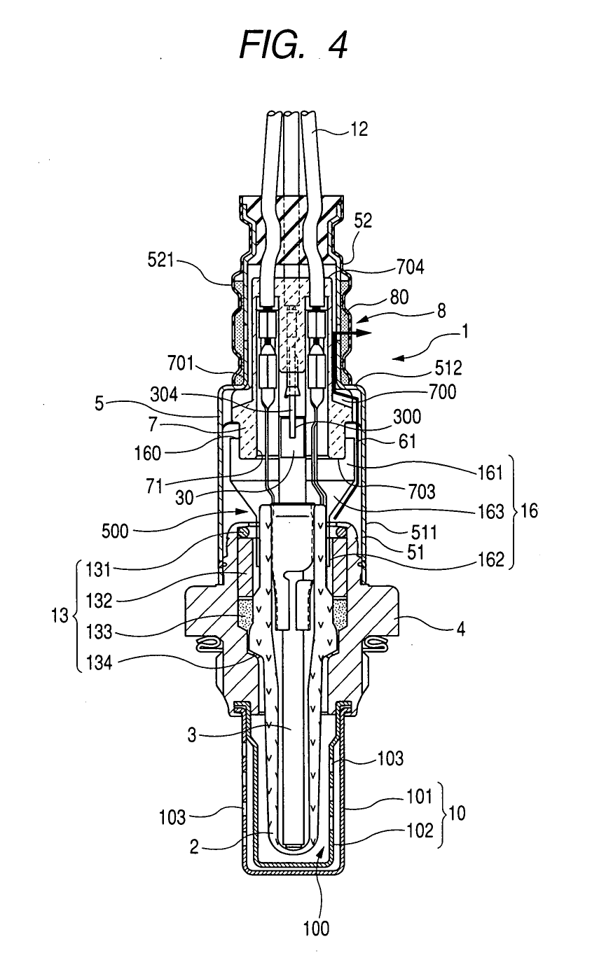

FIG. 4 illustrates the gas sensor 1 according to the third embodiment of the invention which is different in structure from the first embodiment in that a shroud assembly 16 is installed on the base end of the sensor element 2 to direct the flow of the measurement gas to the outer gas flow path 61.

The shroud assembly 16 is made up of a first hollow cylinder 161, a second hollow cylinder 162, and a tapered or frustoconical wall 163 extending between the first and second hollow cylinders 161 and 162. The first hollow cylinder 161 is greater in diameter than the second hollow cylinder 162.

The second hollow cylinder 162 is joined to the outer periphery of the base end of the sensor element 2. The first hollow cylinder 161 has a base end 160 which covers the top end 703 of the porcelain insulator 7 and is disposed between the outer periphery of the porcelain insulator 7 and the inner wall of the air cover 5. This structure serves to lead the measurement gas having entered the air cover 5 from clearances between the sensor element 2 or the housing 4 and the sealing assembly 13 to pass through a clearance between the outer periphery of the shroud assembly 16 and the inner wall of the air cover 5 toward the outer gas flow path 61.

Other arrangements are identical with those in the first embodiment, and explanation thereof in detail will be omitted here.

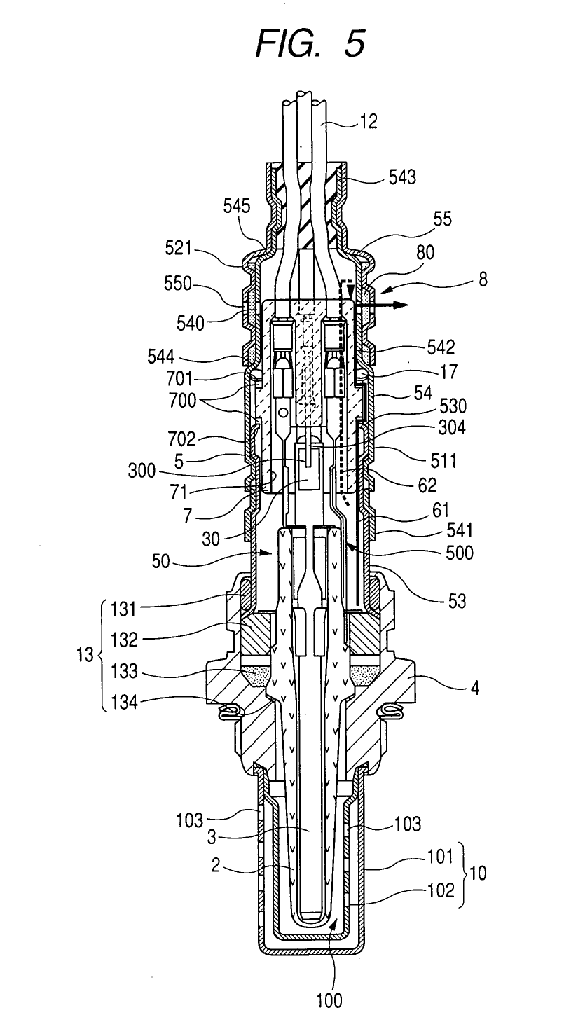

FIG. 5 illustrates the gas sensor 1 according to the fourth embodiment of the invention which is different in structure from the first embodiment in that the air cover 5 is made up of three hollow cylindrical parts: a top end side cylinder 53, a base end side cylinder 55, and a middle cylinder 54 disposed between the cylinders 53 and 55.

The top end side cylinder 53 is retained at a top end thereof by the base end of the housing 4. The top end side cylinder 53 has a base end 530 bent inwardly.

The intermediate cylinder 54 is made up of a large-diameter portion 541, a middle-diameter portion 542, and a small-diameter portion 543. The large-diameter portion 541 extends toward the base end of the housing 4. The middle-diameter portion 542 extends between the large-diameter portion 541 and the small-diameter portion 543. The small-diameter portion 543 extends toward the base end of the sensor element 2. The intermediate cylinder 54 also has a shoulder 544 formed between the small-diameter portion 543 and the intermediate-diameter portion 542. The large-diameter portion 541 is placed to cover the based end 530 of the top end side cylinder 53 circumferentially.

The base end side cylinder 55 is placed to cover a portion of the intermediate cylinder 54 circumferentially which extends from the shoulder 544 to the base end thereof.

The small-diameter portion 521 of the air cover 5 has the water-repellent filter 80 retained between the middle-diameter portion 542 of the intermediate cylinder 54 and a top end portion of the base end side cylinder 55. The filter 80, like the first embodiment, allows air to passes therethrough.

The base end side cylinder 55 has air inlets 550 formed circumferentially. The intermediate cylinder 54 has air passage openings 540 formed circumferentially. Each of the ventilators 8 is made up of one of the air inlets 550, one of the air passage openings 540, and the filter 80.

The porcelain insulator 7 is nipped elastically in a lengthwise direction of the gas sensor 1 between the base end 530 of the top end side cylinder 53 and the shoulder 544 of the intermediate cylinder 54. A spring 17 is interposed between the shoulder surface 701 of the porcelain insulator 7 and the inner surface of the shoulder 544 of the intermediate cylinder 54 and compressed thereby in the lengthwise direction of the gas sensor 1.

The porcelain insulator 7 also has a lower shoulder 702 facing the base end 530 of the top end side cylinder 53. The lower shoulder 702 has formed therein the grooves 700 which form clearances between the base end 530 of the top end side cylinder 53 and the lower shoulder 702 to define portions of the outer gas flow path 61.

The outer gas flow path 61, like the first embodiment, functions to lead the measurement gas having entered the air cover 5 from the inner chamber 50 outside the gas sensor 1 through the ventilations 8.

We performed corrosion tests, as discussed below, to evaluate the degree of corrosion of the brazed joints 300 between the terminals 30 of the heater 3 and the terminal leads 304 extending from the leads 12.

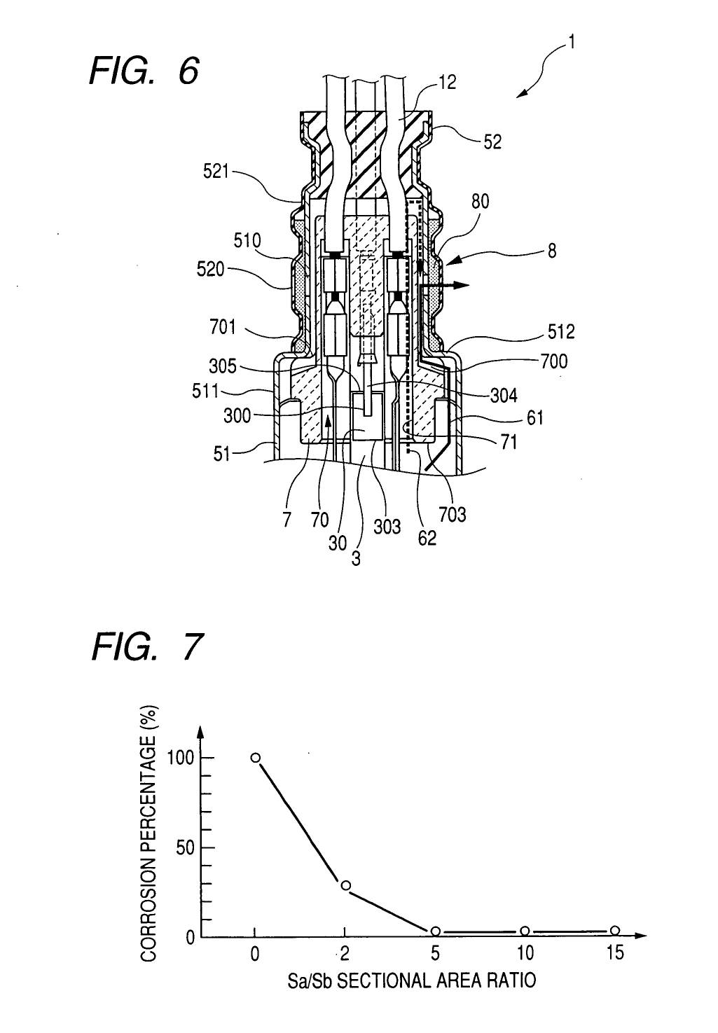

We first prepared test samples of the gas sensor 1, as illustrated in FIG. 6, which had different values of the Sa/Sb ratio where Sa is, as described above, the minimum cross sectional area of the outer gas flow path 61, and Sb is the minimum cross sectional area of the inner gas flow path. The corrosion tests were performed by forcing the measurement gas directly into the test samples in real vehicle environments.

In each of the test samples, the top end 703 of the porcelain insulator 7 was located 5 mm closer to the top end of the gas sensor 1 (i.e., the lower side in the drawing) than the base end 305 of each of the terminals 30 of the heater 3. The inner gas flow path 62 had a sectional area of 45 mm² at the brazed joints 300 between the terminals 30 of the heater 3 and the terminal leads 304. The length of the terminals of the heater 3, as defined in the axial direction of the gas sensor 1, was 5 mm. These dimensions were true for test samples, as discussed later.

After the tests, we checked the test samples for the percentage of corrosion of the brazed joints 300 that was a ratio of an area of corroded portions of the brazed joints 300 to the overall surface area thereof. FIG. 7 is a graph which represents results of the corrosion tests. We found that when the Sa/Sb ratio is greater than or equal to 2, the percentage of corrosion lies within a permissible range, and when the Sa/Sb ratio is greater than or equal to 5, the brazed joints 300 hardly corrode.

We also performed tests to check the accuracy in measuring the concentration of exhaust gas from an automotive engine.

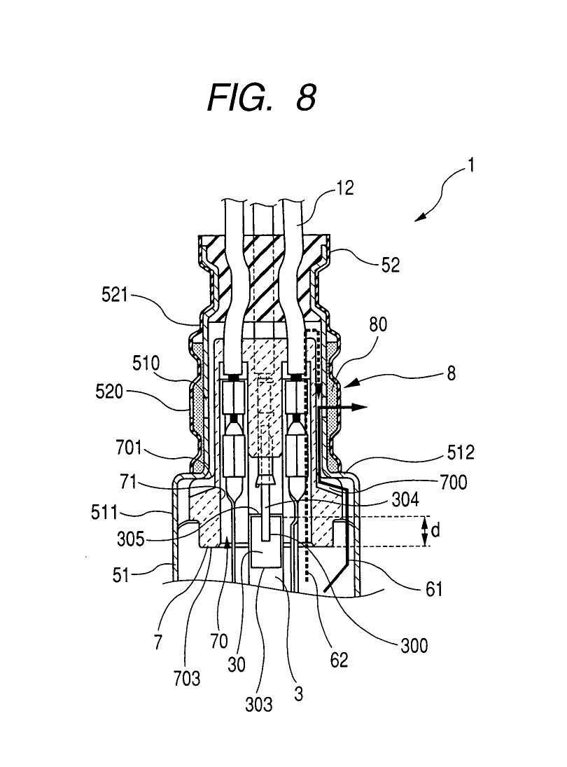

We prepared test samples of the gas sensor 1, as illustrated in FIG. 8, which had different values of the distance d between the top end 703 of the porcelain insulator 7 and the base end 305 of each of the terminals 30 of the heater 3. We placed the test samples in real vehicle environments and operated them to measure the concentration of exhaust gas around the terminals 30 of the heater 3.

In each of the test samples, the Sa/Sb ratio was 5. The inner gas flow path 62 had a sectional area of 45 mm² at the brazed joints 300 between the terminals 30 of the heater 3 and the terminal leads 304.

The fact that the distance d is greater than zero (0) means that the top end 703 of the porcelain insulator 3 is placed closer to the top end of the gas sensor 1 (i.e., the lower side in the drawing) than the base end 305 of each of the terminals 30 of the heater 3. The fact that the distance d is zero (0) means that the top end 703 of the porcelain insulator 3 lies in flush with the base end 305 of each of the terminals 30 of the heater 3 in a direction perpendicular to the length of the gas sensor 1. The fact that the distance d is lower than zero (0) means that the top end 703 of the porcelain insulator 3 is placed closer to the based end of the gas sensor 1 (i.e., the upper side in the drawing) than the base end 305 of each of the terminals 30 of the heater 3.

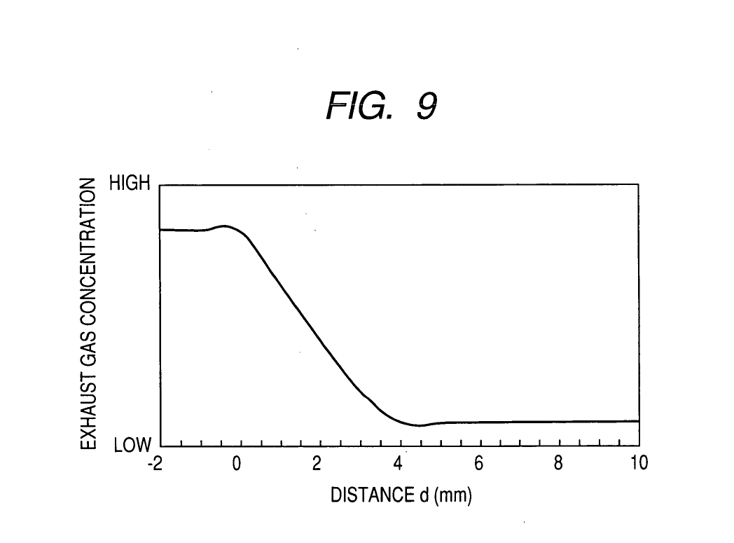

FIG. 9 is a graph which represents results of the tests. The graph shows that when the distance d is greater than or equal to 5 mm, the measured concentration of exhaust gas will be small, and the distance d is in a range of 0 to 5 mm, the concentration of exhaust gas will decrease as the distance d increases. It is, therefore, found that when the top end 703 of the porcelain insulator 7 projects downward from the base end 305 of each of the terminals 30 of the heater 3, in other words, when the porcelain insulator 7 surrounds the based end 305 circumferentially, the porcelain insulator 7 functions to direct the measurement gas having entered the air cover 5 to the outer gas flow path 61 to decrease the exposure of the terminals 30 to the measurement gas.

In terms of production costs of the porcelain insulator 7, the top end 703 of the porcelain insulator 7 and the top end 303 of each of the terminals 30 of the heater 3 are preferably placed on the same level in the lengthwise direction of the gas sensor 1.

We also performed dew condensation tests, as discussed below, to evaluate the degree of dew condensation on the brazed joints 300 between the terminals 30 of the heater 3 and the terminal leads 304 extending from the leads 12.

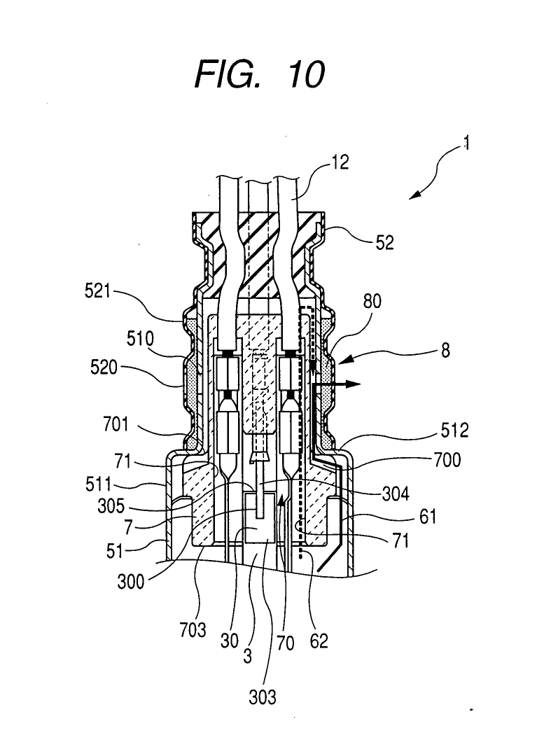

We prepared test samples of the gas sensor 1, as illustrated in FIG. 10, which had different values of a sectional area of the inner gas flow path 62 at the brazed joints 300. The dew condensation tests were performed by injecting a constant amount of water to around the base end of the sealing assembly 13 and then heating the samples. We performed the dew condensation tests on each of the test samples ten (10) times, measured the amount of dew condensation on the brazed joints 300, and found the number of times the water was condensed on the brazed joints 300.

In each of the test samples, the top end 703 of the porcelain insulator 7 was located 5 mm closer to the top end of the gas sensor 1 (i.e., the lower side in the drawing) than the base end 305 of each of the terminals 30 of the heater 3. The Sa/Sb ratio was 5.

The sectional area of the inner gas flow path 62 at the brazed joints 300, as referred to herein, is a sectional area of the inner chamber 70 of the porcelain insulator 7 on a plane extending perpendicular to the axial direction of the gas sensor 1 through the brazed joints 300 (see FIG. 2) excluding sectional areas of the heater 3 and the terminal leads 204 and 304.

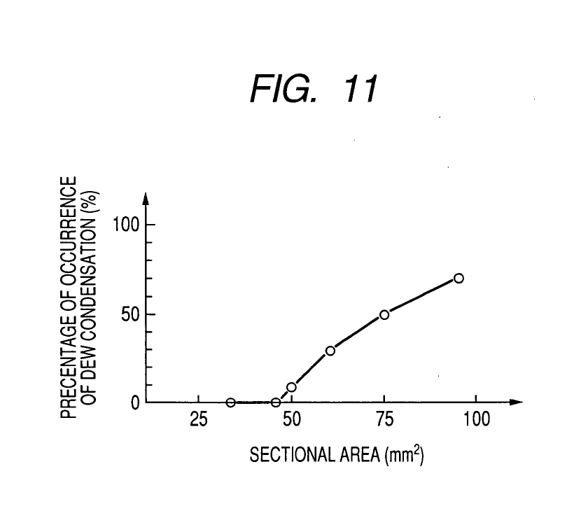

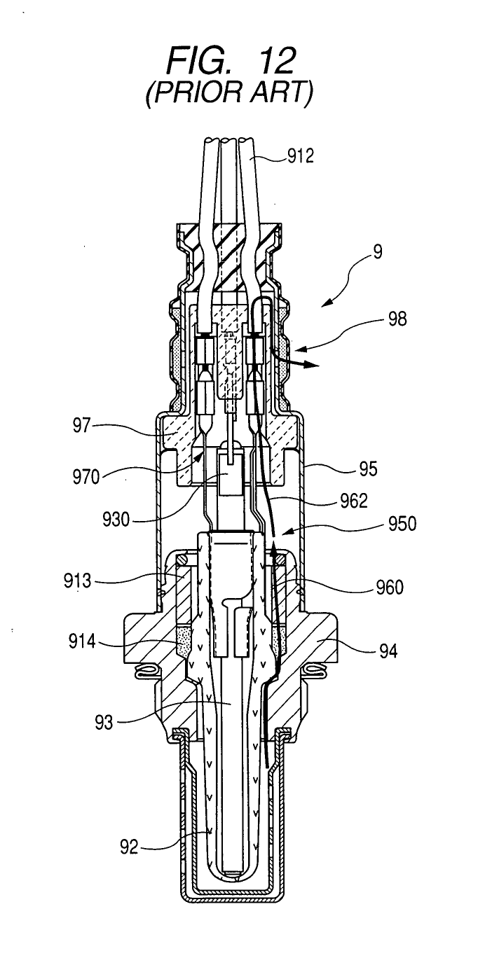

FIG. 11 is a graph which represents results of the dew condensation tests. We found that when the sectional area of the inner gas flow path 62 at the brazed joints 300 is less than or equal to 50 mm², the percentage of occurrence of the dew condensation will be approximately 10% which is within a permissible range, and when the sectional area is less than or equal to 45 mm², the percentage of occurrence of the dew condensation will be substantially zero (0).

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. A gas sensor having a length with a top end and a base end opposite the top end, comprising:
a sensor element responsive to a concentration of a given gas to output a signal indicative thereof;
a heater disposed inside said sensor element to heat said sensor, said heater having a base end, a top end opposite the base end, and a terminal provided on an outer surface of the base end;
a housing having a top end and a base end opposite the top end, said housing retaining said sensor element therethrough;
leads connecting electrically with said sensor element and the terminal of said heater;
a porcelain insulator retaining said leads therein and surrounding the terminal of said heater, said porcelain insulator having a shoulder surface;
an air cover including a large-diameter portion, a small-diameter portion, and a shoulder formed between the large-diameter portion and the small-diameter portion, the large-diameter portion being joined to the base end of said housing, the small-diameter portion being equipped with a ventilator, said air cover retaining therein said porcelain insulator in abutment of the shoulder with the shoulder surface of said porcelain insulator;
a recess formed in the shoulder surface of said porcelain insulator;
an inner chamber defined inside said air cover between said porcelain insulator and the base end of said housing; and
an outer gas flow path defined to extend from said inner chamber to said ventilator through a clearance between an outer periphery of said porcelain insulator and an inner periphery of said air cover and said recess to lead the gas having entered said inner chamber outside the sensor.

2. A gas sensor as set forth in claim 1, wherein the terminal of said heater has a top end and a base end which is opposite the top end and located closer to the top end of the sensor then the base end thereof, and wherein said porcelain insulator has a top end located closer to the top end of the sensor than the top end of the terminal of said heater.

3. A gas sensor as set forth in claim 1, further comprising an inner gas flow path defined to extend from said inner chamber to outside the sensor through an inner chamber which is formed inside said porcelain insulator and through which said lead extend, and wherein said outer gas flow path has a minimum cross sectional area Sa defined perpendicular to a length thereof, said inner gas flow path having a minimum cross sectional area Sb which is defined perpendicular to a length thereof and meets a relation of Sa/Sb≧2.

4. A gas sensor as set forth in claim 3, wherein the minimum cross sectional area Sa and the minimum cross sectional area Sb meet a relation of Sa/Sb≧5.

5. A gas sensor as set forth in claim 1, further comprising a sealing member disposed on a base end of said porcelain insulator located closer to the base end of the gas sensor to block said outer gas flow path.

6. A gas sensor as set forth in claim 1, further comprising a shroud with a first end and a second end opposite the first end, said shroud being installed at the first end thereof on the base end of the sensor element and extending to have the second end around an outer periphery of said porcelain insulator to direct flow of the gas to said outer gas flow path.
